(19) United States
(12) Patent Application Publication
(10) Pub. No.: US 2026/0330143 A1
(43) Pub. Date: Oct. 22, 2026

(54) Artificial Intelligence System for Rhetorical Assessment and Feedback Generation for Written Compositions

(71) Applicant: JAMAL ABD ASSLAM KHLIFAT, Louisville, CO (US)

(72) Inventor: JAMAL ABD ASSLAM KHLIFAT, Louisville, CO (US)

(73) Assignee: Datanatic LLC, Louisville, CO (US)

(21) Appl. No.: 19/693,588

(22) Filed: Jun. 1, 2026

(51) Int. Cl. G06F 40/30; G06F 16/38; G06F 21/62; G06F 40/103

(52) U.S. Cl. CPC G06F 40/30; G06F 16/382; G06F 21/6254; G06F 40/103

(57) ABSTRACT

A computer-implemented system and method for automated evaluation of written compositions is disclosed. The system employs a modular artificial intelligence pipeline to preprocess documents, anonymize personally identifiable information, isolate argumentative content, evaluate writing using rubric-based scoring, verify citations using external databases, and generate structured feedback. The system supports batch processing, caching, and external artificial intelligence computation to improve efficiency and consistency.

### CROSS-REFERENCE TO RELATED APPLICATIONS

None.

### STATEMENT REGARDING FEDERALLY SPONSORED RESEARCH OR DEVELOPMENT

Not applicable.

### BACKGROUND OF THE INVENTION

### Field of the Invention

The present invention relates to computer-implemented systems for automated analysis of written compositions, and more specifically to artificial intelligence-based systems configured to perform structured document segmentation, rubric-based evaluation, citation verification, and automated feedback generation.

### Description of Related Art

Conventional automated writing evaluation systems primarily evaluate surface-level linguistic properties such as grammar, spelling, and readability. Such systems generally lack robust mechanisms for:
isolating argumentative content from non-argumentative document regions,
performing structured rhetorical analysis,
verifying citations using external authoritative databases, and
generating consistent rubric-based instructional feedback.

Accordingly, there exists a need for a modular computational system that separates document ingestion, preprocessing, evaluation, verification, and output generation into distinct processing stages.

### SUMMARY OF THE INVENTION

The invention provides a computer-implemented system and method for automated evaluation of written compositions using a modular artificial intelligence processing pipeline.

In one embodiment, a digital document is received and processed by a document parsing engine configured to extract and structure document content.

The system applies a privacy transformation layer to anonymize personally identifiable information prior to external processing. The anonymized content is then processed by a structural segmentation engine configured to isolate argumentative content.

The system further includes an artificial intelligence evaluation pipeline comprising an analysis module, scoring module, feedback generation module, and audit module.

The system additionally incorporates a citation verification engine configured to validate references using external databases, a citation formatting engine, and an external artificial intelligence processing engine with a context caching system.

The system outputs structured evaluation results including grading reports, annotated documents, and instructional feedback.

### BRIEF DESCRIPTION OF THE DRAWINGS

FIG. 1 illustrates a modular system architecture for automated evaluation of written compositions including document ingestion, preprocessing, privacy transformation, structural segmentation, artificial intelligence evaluation, citation verification, and output generation components.

FIG. 2 illustrates a privacy transformation system (“Ghost Protocol”) configured to anonymize personally identifiable information prior to external processing and restore identifiers after processing using a secure mapping mechanism.

FIG. 3 illustrates an integrated system overview showing interaction between document processing, privacy transformation, artificial intelligence evaluation, external verification, and output generation subsystems.

### DETAILED DESCRIPTION OF THE INVENTION

### 1. System Overview

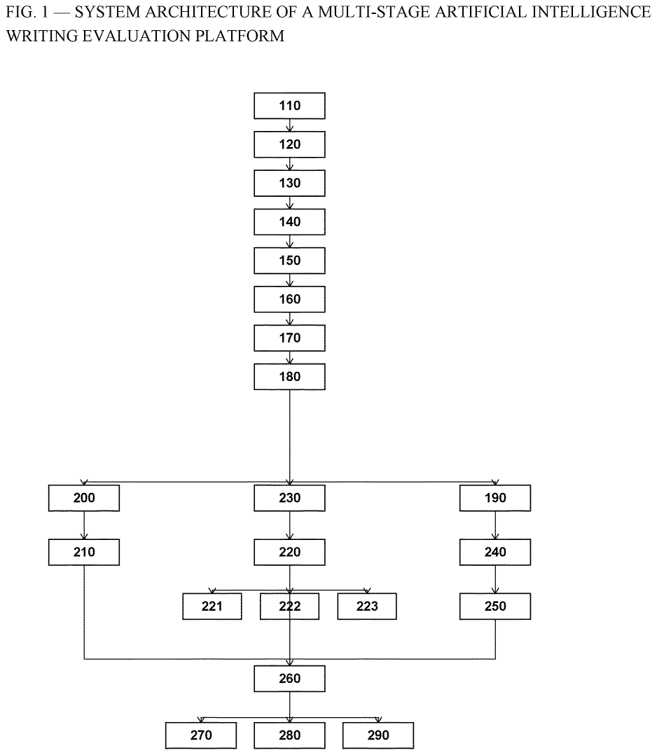

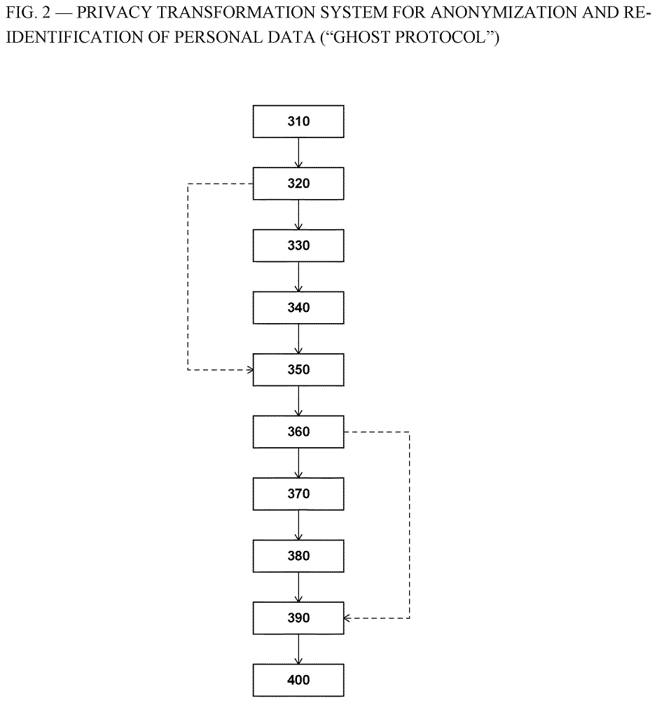

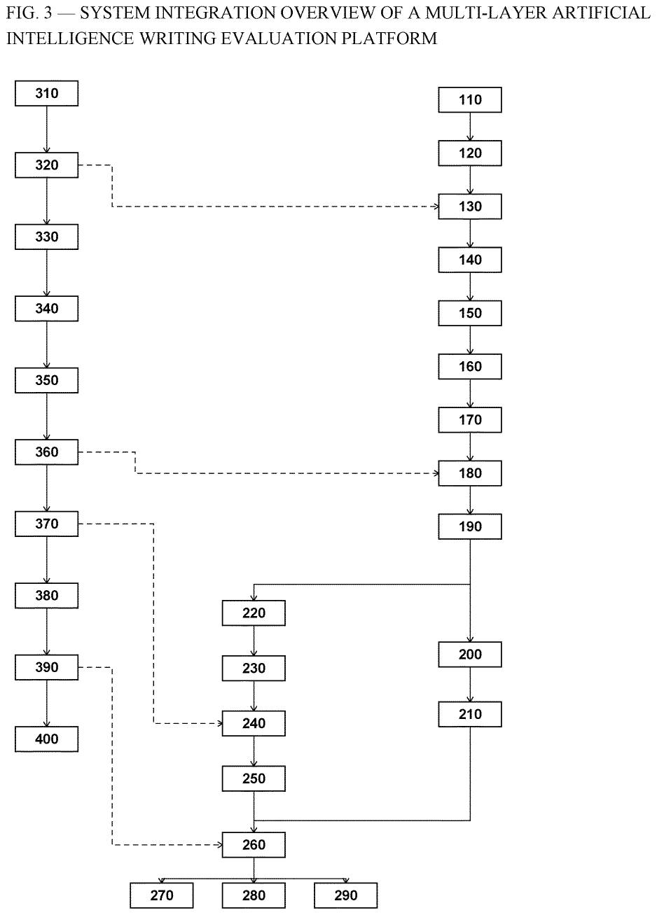

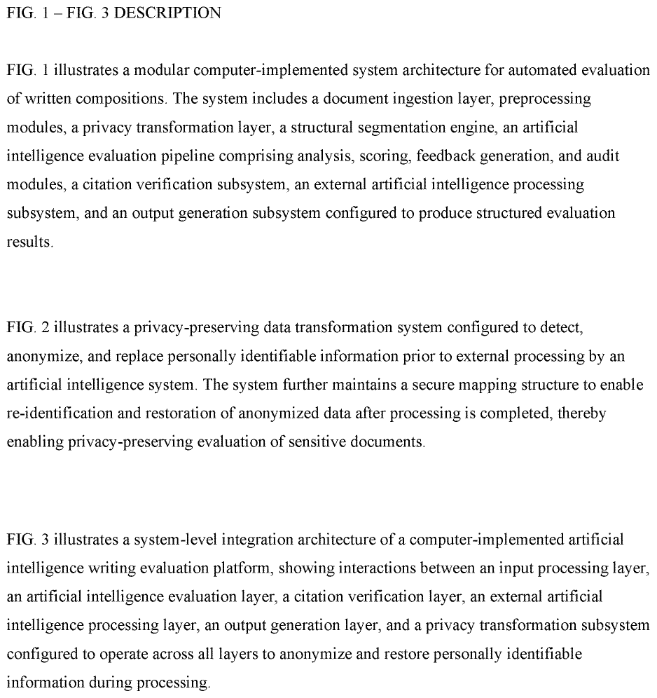

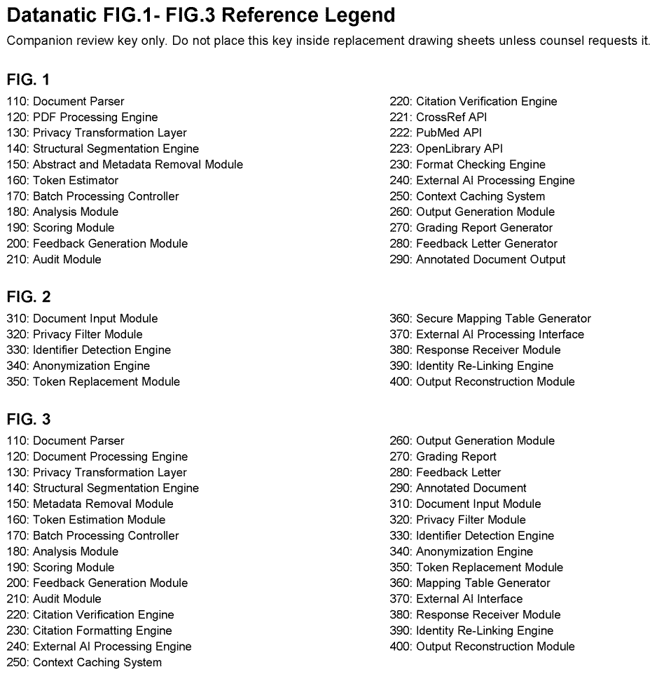

As shown in FIG. 1, the system comprises a modular pipeline architecture configured to process written compositions through a sequence of computational stages including ingestion, preprocessing, evaluation, verification, and output generation.

### 2. Document Ingestion and Processing

A document parser receives a digital document comprising unstructured textual content. The document processing engine extracts structured data elements including text, metadata, and formatting components.

### 3. Privacy Transformation Layer

As shown in FIG. 1 and FIG. 2, a privacy transformation layer is configured to detect personally identifiable information including names, email addresses, and phone numbers. Identified data is replaced with anonymized tokens prior to external processing. A secure mapping table enables restoration of identifiers after processing.

### 4. Structural Segmentation

A structural segmentation engine isolates argumentative content from non-argumentative components such as title pages, references, and metadata sections.

### 5. Artificial Intelligence Evaluation Pipeline

The system includes a modular evaluation pipeline comprising:
an analysis module configured to identify rhetorical structure,
a scoring module configured to apply rubric-based evaluation,
a feedback generation module configured to produce instructional feedback, and
an audit module configured to enforce scoring consistency.

### 6. Citation Verification and Formatting

A citation verification engine validates references using external databases including CrossRef, PubMed, and OpenLibrary. A citation formatting engine verifies adherence to citation standards including MLA, APA, and Chicago formatting rules.

### 7. External AI Processing and Caching

An external artificial intelligence processing engine performs computational evaluation using cached rubric data stored in a context caching system to reduce redundant processing.

### 8. Batch Processing and Optimization

A batch processing controller manages concurrent evaluation of multiple documents and regulates computational resource allocation and external API usage.

A token estimation module predicts computational cost prior to processing.

### 9. Output Generation

An output generation module produces structured outputs including:
grading reports,
feedback letters, and
annotated document versions.

1. A computer-implemented method for automated evaluation of written compositions comprising the steps of:
receiving a digital document via a document parser;
processing the digital document using a document processing engine;
anonymizing personally identifiable information using a privacy transformation layer prior to external processing;
segmenting the anonymized document using a structural segmentation engine to isolate argumentative content;
removing non-argumentative content using a metadata removal module;
processing the segmented content using an artificial intelligence evaluation pipeline comprising an analysis module, a scoring module, a feedback generation module, and an audit module;
verifying citations using a citation verification engine in communication with one or more external databases;
validating citation formatting using a citation formatting engine;
processing evaluation data using an external artificial intelligence processing engine in communication with a context caching system; and
generating structured output data using an output generation module.

2. The method of claim 1, wherein the artificial intelligence evaluation pipeline executes in a sequential processing order comprising the analysis module (180), the scoring module (190), the feedback generation module (200), and the audit module (210).

3. The method of claim 1, wherein the structural segmentation engine (140) and the metadata removal module (150) collectively isolate argumentative content from non-argumentative portions of the digital document.

4. The method of claim 1, wherein the citation verification engine (220) validates references by accessing at least one external database selected from CrossRef (221), PubMed (222), and OpenLibrary (223).

5. The method of claim 1, wherein citation verification is performed without generative language model inference, and wherein citation existence is confirmed using deterministic database lookup operations.

6. The method of claim 1, wherein the privacy transformation layer (130) anonymizes personally identifiable information prior to processing by the artificial intelligence evaluation pipeline.

7. The method of claim 6, wherein anonymizing the personally identifiable information comprises replacing detected identifiers with tokenized placeholders using a token replacement module (350) and storing mapping relationships in a secure mapping table (360) as illustrated in FIG. 2.

8. The method of claim 1, wherein the audit module (210) enforces rubric-based scoring constraints by validating consistency between detected argumentative structure and assigned evaluation scores.

9. The method of claim 1, wherein the feedback generation module (200) generates instructor-configurable instructional feedback based on cached rubric data stored in a context caching system (250).

10. The method of claim 1, wherein the batch processing controller (170) processes a plurality of digital documents concurrently while regulating computational throughput and external application programming interface constraints.

11. The method of claim 1, wherein the token estimation module (160) estimates computational resource requirements prior to execution of the artificial intelligence evaluation pipeline.

12. The method of claim 1, wherein the context caching system (250) stores rubric definitions and intermediate evaluation states to reduce redundant computational processing across multiple documents.

13. The method of claim 1, wherein the output generation module (260) generates at least one of a grading report (270), a feedback letter (280), and an annotated document (290) containing margin-based instructional comments.

14. The method of claim 10, wherein the artificial intelligence evaluation pipeline and the citation verification engine operate in parallel processing paths to improve evaluation throughput.

15. A non-transitory computer-readable storage medium storing instructions that, when executed by one or more processors, cause performance of the method of claim 1, including anonymizing input data, segmenting argumentative content, performing rubric-based evaluation, and generating structured instructional feedback.
